(19) United States
(12) Patent Application Publication
(10) Pub. No.: US 2008/0102787 A1
(43) Pub. Date: May 1, 2008

(54) MOBILE COMMUNICATIONS HANDOVER METHOD

(75) Inventors: Assaf Landschaft, Muenchen (DE); Michael King, Axams (AT)

Correspondence Address: HITT GAINES, PC;LSI Corporation, PO BOX 832570, RICHARDSON, TX, 75083, US

(73) Assignee: Agere Systems Inc., Allentown, PA (US)

(21) Appl. No.: 11/554,703

(22) Filed: Oct. 31, 2006

(51) Int. Cl. H04M 11/04

(52) U.S. Cl. 455/404.2

(57) ABSTRACT

A power saving method for connecting a mobile communications device to a network. In one embodiment the method includes; (1) detecting an approximate location; (2) comparing the approximate location with a database of location related information; and (3) automatically activating or deactivating an interface with the network based on the approximate location.

### TECHNICAL FIELD OF THE INVENTION

The present invention is directed, in general, to mobile communications and, more particularly, to a method for providing inter-system handovers of mobile communications devices.

### BACKGROUND OF THE INVENTION

Prior art dual mode mobile communication devices all provide some means for the automatic transfer of a connection from one network to another. For example, when a mobile communications device being used in a wireless local area network operated in accordance with Institute of Electrical and Electronics Engineers (IEEE) 802.11 standard moves into a wireless environment operating as a Global System for Mobile Communications (GSM) network, a mobile communications device must be able to make a transfer from the 802.11 network to the GSM network in as seamless a manner as possible. The transition must not only be made to maintain connectivity, but also to keep track of which network is providing the connectivity for revenue determination purposes. Those skilled in the pertinent art commonly refer to a transfer between such networks as a handover or, more precisely, as an inter-system handover.

A mobile communications device operating within a wireless network will periodically conduct a transmission check to verify that it is within a transmission and receiving hotspot. For example, if it is operating in a wireless network operating in accordance with the 802.11 standard, the device will periodically transmit to see if it is within range of an 802.11 hotspot. Such radio frequency checks and the automatic transfers between networks, such as between GSM and 802.11 networks, consume considerable device battery power with a resulting reduced battery life.

Prior art power conservation efforts have included attempts to reduce power consumption by means of hardware improvements, such as the development of antennas and chips that consume less power. Another approach to reduce power consumption has focused on software, particularly time-based software based on power saving algorithms for searching a network. For example, when a mobile communications device is not connected to an 802.11 hotspot, it automatically searches for one hotspot every increasing time interval such as X milliseconds for the first time interval, followed by 2X milliseconds for the second time interval, etc.

Accordingly, what is needed in the art is an advanced network connecting service to enable mobile communication devices to be efficiently transferred from one geographic network area to another with a minimum expenditure of power.

### SUMMARY OF THE INVENTION

To address the above-discussed deficiencies of the prior art, the present invention provides for a power saving method for connecting a mobile communications device to a network. In one embodiment the method includes; (1) detecting an approximate location; (2) comparing the approximate location with a database of location related information; and (3) automatically activating or deactivating an interface with the network based on the approximate location.

Thus, a new and novel method of handing over a mobile communications device from one network to another network is provided for that is based on a database of geographic network information embodied within the memory of the mobile communications device. The device advantageously provides for an inter-network transfer without requiring the device to conduct transmission activities to search for a suitable network connection. This results in considerable power savings for the device due to the reduction of transmission time, which, as is known to those skilled in the pertinent art, is a high power consumption activity.

In one embodiment, the method is used with a mobile phone having a dual mode function. In another, the method is used where the network is operated according to a standard selected from the group consisting of GSM standards, UMTS standards, wireless standards, and IEEE 802.11 standards.

In still another embodiment the method provides for the approximate location to be provided as a geographic location. In another embodiment, the approximate location is determined by a connection address. In yet still another embodiment, the approximate location is determined by a connection address that is either a communication cell-ID or a hot spot address.

In a particularly useful embodiment, the invention provides for the selection of at least one network from a plurality of networks. In another embodiment, the method provides for automatically connecting the mobile communication device to at least one network out of a plurality of networks. Another embodiment provides for handing over the mobile communications device from at least one network in the plurality of networks to a second network in the plurality of networks.

Another useful embodiment of the present invention provides for the comparing to be performed in time intervals dependent on the approximate location of the mobile communications device. In another, the time intervals are further dependent on the movement of the mobile communications device. An embodiment of the method provides for the system to generate a ranking. In one embodiment, the ranking is related to a moment.

The invention also provides an embodiment of the method that includes calculation of a coverage area of the network by using the location related information. Also provided is an embodiment wherein the location related information is determined based on information selected from the group consisting of network performance, network rate, network connection quality and network power consumption.

The invention also provides for a mobile communications device, that in one embodiment includes; (1) a means for detecting an approximate location of the mobile communication device; (2) interfaces for being connectable to at least two different networks; (3) a means for comparing the approximate location with a database comprising network related information, in particular network availability related information; and (4) a means for automatically activating or deactivating at least one of the interfaces based on the approximate location.

The invention includes an embodiment that provides for the mobile communications device to be a mobile phone having a dual mode function. In another embodiment, the mobile communications device includes a means for detecting a geographic location. In still another embodiment, the mobile communications device includes a means for automatically connecting to at least one of the networks. In yet still another embodiment, the mobile communications device includes a means for handing over the mobile communications device from at least one of the networks to another of the networks. A useful embodiment of the present invention provides for the mobile communications device to include a means for automatically adapting time intervals for comparing.

The invention is explained subsequently in more detail on the basis of preferred embodiments and with reference to the appended figures. The features of the different embodiments are able to be combined with one another. Identical reference numerals in the figures denote identical or similar parts.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a representational schematic of a mobile communication device in a communication network detecting its location according to GSM or UMTS and wireless standards;

FIG. 2 illustrates a schematic representation of a wireless network of the type operated in accordance with the 802.11 WLAN standard and detection of the location of a mobile communications device operating in a communications network according to GSM or UMTS standards; and

FIG. 3 illustrates a flow chart showing the sequence by which a dual mode mobile phone would connect with a network in accordance with one embodiment of the present invention.

### DETAILED DESCRIPTION

Before describing the FIGUREs, various aspects, embodiments and features of the invention will be described. The present invention provides a method for connecting a mobile communications device to a network, wherein the mobile communications device has an interface for at least two different networks. The method includes the detection or tracking of the approximate location of the mobile communications device and the comparing of the approximate location with a database in the mobile communications device of network related information regarding network availability based on the approximate location of the mobile communications device. The interface is then automatically activating or deactivating based on this information.

The invention also includes a device to be incorporated in the mobile communication device that detects an approximate location of the mobile communication device and the relevant interfaces for connecting to at least two different networks. The device compares the approximate location with network related information in a database and automatically activates or deactivates at least one of the interfaces based on such approximate location.

In one embodiment of the invention the database relating to network related information is in the memory of the mobile communication device. In one such embodiment the database is embodied in the device's memory as a lookup table that maps network related information to geographic locations. The database can be automatically and/or dynamically updated by way of a connection to a server that has a database assigned to provide such updates. In another embodiment, the database can be assigned to a network and be made accessible via the Internet.

To be connected to a certain network, the mobile communication device must, of course, be within the coverage area of the network. The network related information can be provided based on information selected from a group consisting of network performance, network rate, network connection quality and network power consumption. Network connection quality for a location will include information regarding traffic estimates as well as signal quality and/or signal amplitude. For example, a selected or preferred network might be available, but if the data traffic on such network is overcrowded, the connection quality or transmission rate might be poor. Also, although a specific network is available, if the mobile communication device is on the edge of the coverage area, the signal quality may be poor or the signal amplitude small, which would require signal amplification by the mobile communication device.

The interfaces can be either hardware or software based or a combination of hardware and software. The interfaces enable the mobile communication device to be connected to at least one network or a plurality of networks. These interfaces provide the radio frequency matching activity to enable network connectivity. A mobile communications device with a single such interface is within the intended scope of the present invention, if that interface enables the connection of a mobile communication device to different networks simultaneously or to one after the other.

A particularly useful embodiment of the invention provides for the mobile communications device to be a mobile phone that has a dual or a multiple mode function. A mobile communication device with a dual mode function has the capability to be connected or connectable to a plurality of networks, either in a parallel or in a serial connection. Other embodiments provide for the mobile communication device to be a laptop or a palm with the capability of being able to determine its approximate geographic location, provided it has the capability of being connected to at least two different networks.

The present device can be usefully employed in association with any type or kind of network that constitutes a communications system or information exchange system between mobile communication devices and/or non-mobile communication devices. In one embodiment, the network is the Internet.

Of course, as will be readily understood by those skilled in the pertinent art, networks can be and are operated in accordance with different technical standards. The present invention can also be usefully employed when the networks are operated in accordance with identical or similar technical standards, such as when similar networks have different ownership.

The connection of the mobile communication device to a network is usually a wireless connection operating in accordance with one of the established standards. Currently the standards for operating a mobile communication will be selected from the group consisting of GSM standards, UMTS standards and wireless network standards. In one embodiment of the invention, the wireless standard is based on IEEE 802.11 standards.

As previously alluded to, the mobile communications device must be able to determine its geographic location. Therefore, the relevant mobile communication device must include a mechanism for detecting or tracking its approximate location. The mobile communication device can be enabled to detect or track its approximate location continuously or at certain intervals. In one embodiment, the location corresponds to the geographic location of the mobile communication device.

In one embodiment of the invention, the approximate location of the mobile communications device is determined by its one connection address or connection identification with a corresponding network. When operated in accordance with GSM and/or UMTS standard networks, the approximate location is determined via communication cell-ID's. A supplemental or alternative way to determine an approximate location when operating in accordance with one of the foregoing standard networks is to use the pertinent hotspot addresses. This embodiment can be implemented, for example, via communication cell-ID and/or via the hotspot address by using a lookup table that maps cell-IDs and/or hot spot addresses to specific locations. Such a lookup table would include the coverage area of a network and the network access points or network connection points, each of which has a particular range. Each network access point to a network is identified by an address or identification code and access to the applicable network is made by way of those network access points. An alternative or supplemental way to determine approximate locations is to use GPS.

Other supplemental or alternative methods to define a geographic location can also be used in connection with the present invention. A defined location can be described by a zone or region having similar characteristics. For example, defined locations for a business may be based on the locations of branches, each having its own wireless local network.

The present invention also provides for a method for connecting a mobile communications device to a network. The method involves the mobile communications device checking or determining its location at certain time intervals. In one embodiment the time intervals are calculated based on approximate location and are dynamically adapted to determine the best available connection. The time intervals also take into consideration any movement of the mobile communications device by tracking both the direction of such movement and the speed of the movement. This kind of comparison activity does not consume a lot of battery power because only a small amount of computing power, such as processor instructions and memory access operations, is required and no radio frequency activity is involved. The time intervals can be set based on the current location of the device or on the direction and speed of movement of the device. For example, if a user is driving in a geographic region where no hotspots are located, the time intervals can be increased. On the other hand, if a user is driving in a geographic region where the density of hotspots is high, the time intervals can be decreased. In one embodiment the time intervals will be periodic.

If a mobile communications device is being used in a coverage area where several networks are available, the invention further includes an embodiment for selecting at least one of these networks for connection. The invention also provides an embodiment that generates a ranking of networks available for connection. This ranking can be based on a rating for each available network. The ranking can be based on predefined parameters or on parameters selected by the user.

In another embodiment of the invention, the ranking of networks is related to access time and/or access date to said networks. The ranking can also be based on the rates charged by each network at the time access is required. Thus, if one network has an inexpensive user rate than another in a specific geographic area or at a specific time where they both have coverage, the system can rate the inexpensive network higher than the more expensive. For instance, if a first network has a cheap rate in the morning but an expensive rate in the afternoon in comparison with a second network, the first network will be rated higher in the morning and the second will be rated higher in the afternoon.

The present invention can be implemented using standard computational algorithms in software adapted to execute the invention. Accordingly, a computer software product adapted or programmed for executing the method described herein is within the intended scope of the present invention. A digital storage medium, such as a microchip, is also within the intended scope of the present invention where such digital storage medium has electronically readable control instructions adapted to execute the present invention when inserted in a mobile communication device.

The present invention thus minimizes power consuming radio frequency activities that would otherwise be performed by a mobile communication device in determining appropriate handover points. The transmission and reception activities of a mobile communication device are activated only if the device is within the coverage area of a selected and available network. If the mobile communication device is within or enters the coverage area of a desired network, a mobile communication device interface is activated. If the mobile communication device leaves the coverage area of a desired network or recognizes a weak connection to such desired network, the corresponding network interface of said mobile communication device with such network is deactivated. Accordingly, mobile communication device power consumption when using an embodiment of the present invention is rendered more efficient and economical.

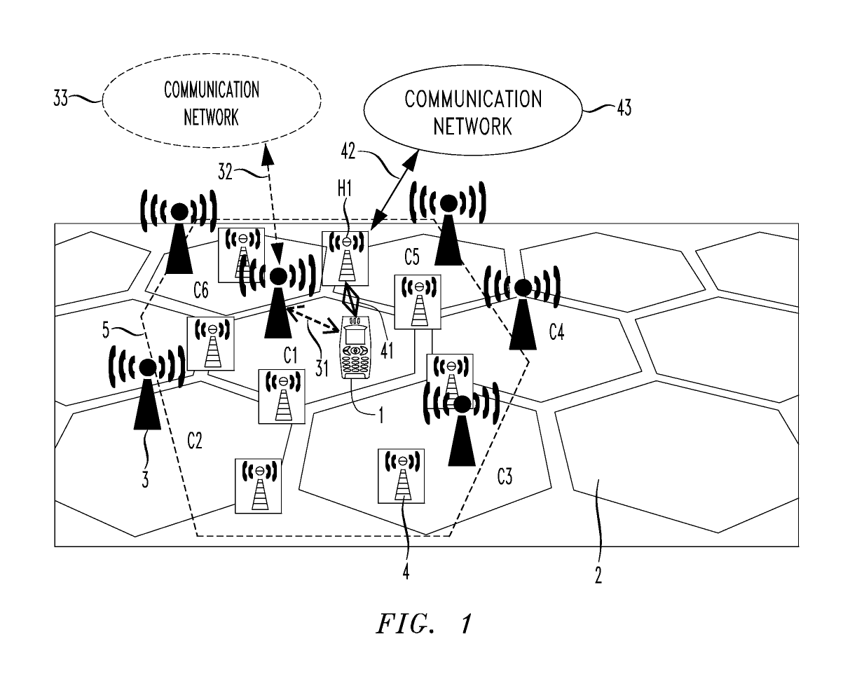

Referring initially to FIG. 1, illustrated is a representational schematic of a mobile communication device in a communication network detecting its location according to GSM or UMTS and wireless standards. A cellular network is shown wherein each cell 2 has a corresponding antenna 3 connected via a connection 32 to a communication network 33. For clarity purposes only a fraction of all antennas 3 and connections 32 are shown. A mobile phone 1 is located in cell C1 and is able to recognize its position in cell C1 via the connection 31 (indicated by full line 31) to antenna 3, which represents the corresponding connecting antenna 3 of cell C1. The approximate mobile phone 1 location is determined via the connection address or communication cell-ID of cell C1 determined, for example, by using a lookup table that maps cell-IDs to locations.

Also illustrated are a number of hotspots 4, in particular 802.11 hotspots 4, spanning a coverage area 5. A hotspot 4 corresponds to a wireless connection in which a user can access a corresponding network 43, such as the Internet or a WLAN network that complies with the 802.11 standard. Within the illustrated coverage area 5, the mobile phone 1 accesses the network 43 via these hotspots 4. The illustrated connection is established via hotspot H1. The illustrated coverage area 5 includes portions of several cells C1 to C6 as well as additional regions. For clarity reasons only a fraction of all the hotspots 4 and connections 42 are labeled and shown. The mobile phone 1 is also able to determine its approximate location or position via its connection 41 (indicated by broken line 41) to hotspot H1. The approximate location of the mobile phone 1 is, for example, determined via a corresponding address for hotspot H1 by way of a lookup table that maps hotspot 4 addresses to their respective locations. Several hotspots 4 are, for example, present in town centers and shopping malls.

The above mentioned lookup tables are located in the mobile phone's memory. The mobile phone 1 will also receive signals originating from antennas that are, for example, located in adjacent cells C2 to C6 and/or from even more remote hotspots 4. Therefore, it may be possible to use this signal information and employ signal analysis technique, such as signal amplitude analysis, to determine or calculate a more precise location of the mobile phone 1.

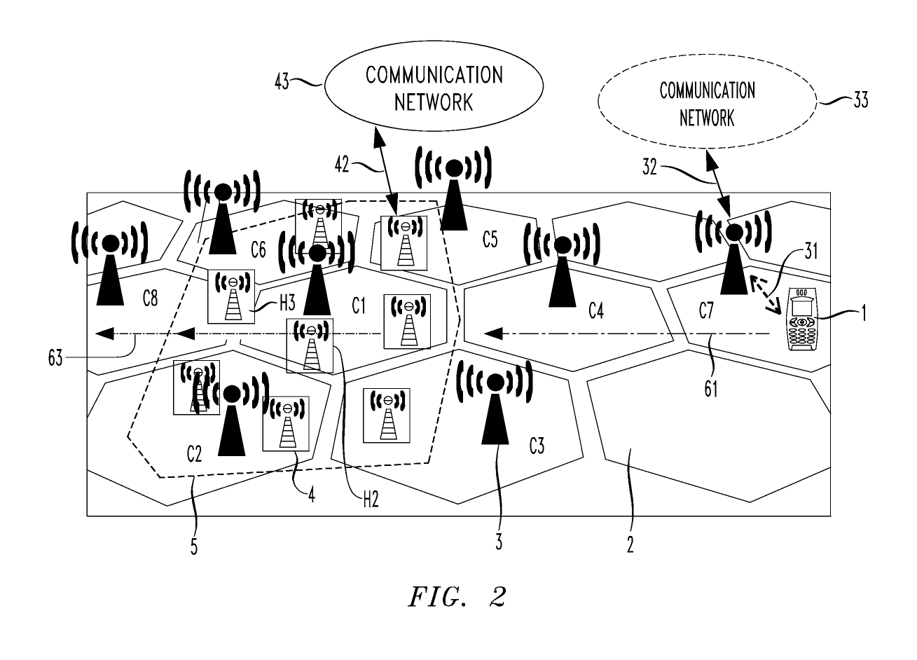

Turning now to FIG. 2, illustrated is a schematic representation of a wireless network of the type operated in accordance with the 802.11 WLAN standard and detection of the location of a mobile communications device operating in a communications network according to GSM or UMTS standards. The representation essentially corresponds to FIG. 1 and shows the mobile phone 1 located in communication or serving cell C7. In the vicinity of cell C7 there are no 802.11 hotspots 4 and, accordingly, no connection to the communication network 43 is available.

By way of connection 31 to GSM or UMTS network 33, the mobile phone 1 can locate its position in cell C7 by, for example, using a database embodied as a lookup table in the memory of the mobile phone that maps cell-IDs to locations, in particular to geographic locations. Networks frequently have their own databases and offer it as a service to their users if the users have applications that require information in the databases, as would be the case in some embodiments of the present invention. These databases can be downloaded to the user's mobile phone for use with the present invention or the database can be accessed by the mobile phone by way of, for example, the Internet network.

The mobile phone 1 compares its actual location with a database made up of wireless network 43 availability information or wireless coverage areas 5. The mobile phone 1 recognizes that it is not actually within a coverage area 5 of a wireless network 43 and that no 802.11 hotspot 4 is present in the surrounding approximate location. Therefore, the mobile phone 1 has no interface with the wireless network 43 and no power consuming radio frequency activity is taking place, nor will it be initialized by the mobile phone 1. An alternative embodiment provides for cell-IDs to be directly related or mapped to network availability related information.

Mobile phone 1 initiates radio frequency activities only if it is within range of a corresponding hotspot 4 or within a coverage area 5 of a corresponding network 43. Mobile phone 1 periodically checks against the database to see if it is within range of a 802.11 hotspot 4. Such checking does not consume a lot of battery power because only a small amount of processor instructions and memory access operations are required and no radio frequency activity is involved. No 802.11 radio frequency activities will be executed or commenced until the database confirms that the mobile phone 1 is within range of a 802.11 hotspot 4.

In one embodiment of the invention, the time interval between checks can be set based on the current location, direction and speed of the mobile phone 1. Such time intervals can be calculated based on location data or location variation data. For instance, if a user of mobile phone 1 driving on a highway traversing a region is covered by serving cells C7 and C4 of a corresponding GSM or UMTS network, the time to traverse cell C7 to reach cell C4 or a time dependent signal amplitude variation of signals emitted from corresponding serving cell antennas can be analyzed to calculate the locomotion speed and direction of the mobile phone 1 to adapt the corresponding check intervals. The system can also be used to predict an entrance time into the coverage area 5 of a corresponding network 43 and a corresponding activation time of a corresponding interface and the commencement of the corresponding radio frequency activity.

For illustration purposes, assume a user of mobile phone 1 is moving along arrows 61, 62 and 63. To get connected to cell C1, the mobile phone 1 detects its position and recognizes its entrance in the coverage area 5 of the wireless network 43. To get connected the mobile phone 1 automatically activates the corresponding interface and establishes a connection to network 43 via hotspot H2. The mobile phone 1 can be connected to both networks 33 and 43 in a parallel manner or an inter-system handover from GSM or UMTS network 33 to wireless network 43 can be performed. As long as the mobile phone 1 is located within the coverage area 5 of the network 43, the mobile phone 1 stays connected to network 33. Within coverage area 5 internal handovers between several hotspots 4 can be performed which handovers are not illustrated.

Since 802.11 connections typically have an enhanced data transmission rate, particularly when compared to a GSM network connection, such connections are particular advantageous for communications involving a large amount of data. For instance the transfer of pictures or of movies will involve the handling of a large amount of data.

When transitioning from an 802.11 wireless network to a GSM or UMTS connection 31, as the mobile phone 1 approaches the border of the coverage area 5, the 802.11 radio activity signals weaken and the mobile phone 1 makes an attempt to connect to cell C8 where hotspots H3 are located according to the mobile phone's 1 database. This is to be contrasted to prior art mobile phones that would generally try to connect within the last cell within which the mobile communications device was connected.

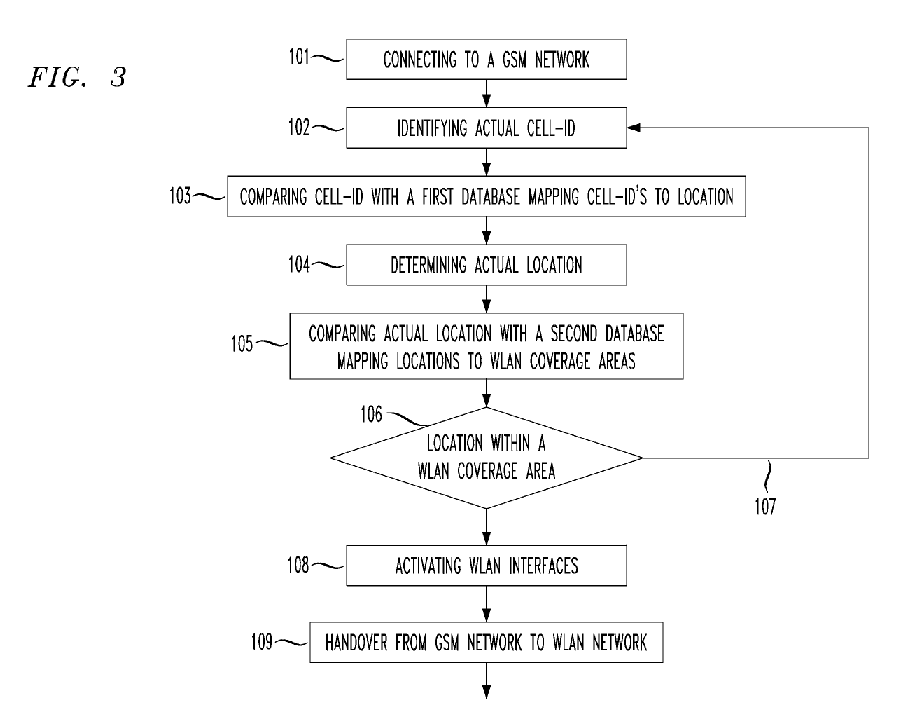

Turning now to FIG. 3, illustrated is a flow chart showing the sequence by which a dual mode mobile phone would connect with a network in accordance with one embodiment of the present invention. The subsequent description of FIG. 3 refers partially to FIGS. 1 and 2.

Initially, in connection step 101, a dual mode mobile phone 1 connects with a network 33 according to GSM standards. In recognition step 102, the mobile phone 1 recognizes the cell-ID of the actual serving cell 2 via its connection with the serving cell 2. To detect the actual approximate location of the mobile phone 1, in particular its actual geographic location, the cell-ID of the serving cell is compared in a comparing step 103. Locations, particularly geographic locations, are stored in a first database mapping cell-ID. Such geographic location can be provided as a 10 or 12-digital number representing geographical locations in a Universal Transverse Mercator grid. The first database is preferably allocated to mobile phone 1 and stored in the memory of mobile phone 1. Determining actual location is determined in location step 104 by way of the comparing step 104.

In a compare location database step 105, the location of mobile phone 1 is compared with a second database that maps locations to WLAN coverage areas 5 in accordance with 802.11 standards. Although two separate databases are described, there may be only one actual database within which will be lodged both the first data base and the second database. These databases can include GSM or UMTS cell details as well or 802.11 hotspot details or both. GSM or UMTS cell details will include all the information necessary for the mobile communications device to initiate a connection with a corresponding GSM or UMTS cell. By the same token, 802.11 hotspot details include all the information needed for the mobile communications device to initiate a connection with a 802.11 hotspot.

Verification step 106 corresponds to an IF-/THEN-operation wherein the mobile phone's actual position is verified as being located within a coverage area 5 of a desired WLAN network 43. If the mobile phone 1 is not located within coverage area 5 of the WLAN network 43, loop 107 reverts back to recognition step 102 and steps 102 to 106 are repeated. If the mobile phone 1 is located within coverage area 5 of the WLAN network 43, interfaces of mobile phone 1 corresponding to the area are activated in activation step 108. The activation step 108 includes an initiation of radio frequency activities. The interfaces correspond to the necessary hardware and software means to get connected to the WLAN network 43.

In a connection step 109, the mobile phone 1 connects to WLAN network 43 via WLAN hotspot 4 wherein WLAN connection is accompanied by disconnection from the GSM network. Accordingly, connection step 109 corresponds to a handover. The handover is optional and not obligatory. A parallel connection to both networks is possible.

Network internal handovers (not shown) can also occur between multiple hotspots 4, enabling a continuous connection of the mobile phone 1 with the WLAN network 43. The multiple hotspots 4 will generally span a corresponding coverage area 5. However, one hotspot can span an entire coverage area 5. If the mobile phone 1 approaches the border of coverage area 5, a GSM connection 32 is established with the actual cell C8 that covers the location of the hotspot H3.

The coverage area 5 can be also determined from network 43 related information of the location and range of hotspots 4. The coverage area 5 can be represented as a concave hull or as a convex hull. To determine if the location of the mobile communication device is within a range, in one embodiment a Graham scan is used.

The present invention integrates current solutions and results in an extended battery life and better user experience. In particular the power consumption is reduced in dual mode, i.e. 802.11 and GSM or UMTS, handheld communication devices that typically have very limited battery power.

As will be understood by those skilled in the pertinent art, the present invention may be embodied in other specific forms without departing from the spirit or central characteristics of the present invention. The examples and embodiments contained herein, therefore, are to be considered in all respects as illustrative and not restrictive, and the invention is not to be limited to the details given herein. Accordingly, the above described sequences of method steps can be exchanged in a reasonable manner.

Although the present invention has been described in detail, those skilled in the art should understand that they can make various changes, substitutions and alterations herein without departing from the spirit and scope of the invention in its broadest form.

What is claimed is:

1. A method for connecting a mobile communications device to a network, comprising:
detecting an approximate location;
comparing said approximate location with a database of location related information; and
automatically activating or deactivating an interface with said network based on said approximate location.

2. The method as recited in claim 1 wherein said mobile communication device is a mobile phone having a dual mode function.

3. The method as recited in claim 1 wherein said network is operated according to a standard selected from the group consisting of GSM standards, UMTS standards, wireless standards, and IEEE 802.11 standards.

4. The method as recited in claim 1 wherein said approximate location is provided as a geographic location.

5. The method as recited in claim 1 wherein said approximate location is determined by a connection address.

6. The method as recited in claim 1 wherein said approximate location is determined by a connection address that is either a communication cell-ID or a hot spot address.

7. The method as recited in claim 1 further comprising selecting at least one network from a plurality of networks.

8. The method as recited in claim 7 further comprising automatically connecting said mobile communication device to said at least one network.

9. The method as recited in claim 7 further comprising handing over said mobile communications device from said at least one network to a second network in said plurality of networks.

10. The method as recited in claim 1 wherein said comparing is performed in time intervals dependent on said approximate location.

11. The method as recited in claim 10 wherein said time intervals are further dependent on the movement of said mobile communications device.

12. The method as recited in claim 1, further comprising generating a ranking of available networks.

13. The method as recited in claim 12 wherein said ranking is related to a moment.

14. The method as recited in claim 1 further comprising the calculating of a coverage area of said network by using said location related information.

15. The method as recited in claim 1 further comprising said location related information determined based on information selected from the group consisting of network performance, network rate, network connection quality and network power consumption.

16. The method as recited in claim 1 wherein said computer software for executing said method is embodied within a microchip.

17. A mobile communications device, comprising:
a means for detecting an approximate location of said mobile communication device;
interfaces for being connectable to at least two different networks;
a means for comparing said approximate location with a database comprising network related information, in particular network availability related information; and
a means for automatically activating or deactivating at least one of said interfaces based on said approximate location.

18. The mobile communications device as recited in claim 17 wherein said mobile communications device is a mobile phone having a dual mode function.

19. The mobile communications device as recited in claim 17 further comprising a means for detecting a geographic location.

20. The mobile communications device as recited in claim 17 further comprising a means for automatically connecting to at least one of said networks.

21. The mobile communications device as recited in claim 17 further comprising a means for handing over said mobile communications device from at least one of said networks to another of said networks.

22. The mobile communications device as recited in claim 17 further comprising a means for adapting automatically time intervals for said comparing.

23. The mobile communications device as recited in claim 17 further comprising electronically readable control instructions embodied in a microchip adapted to execute, when inserted in said mobile communication device, a method for connecting a mobile communications device to a network.
